(19) United States
(12) Patent Application Publication
(10) Pub. No.: US 2008/0091612 A1
(43) Pub. Date: Apr. 17, 2008

(54) TELEPHONE COMMUNICATION SYSTEM AND METHODS

(76) Inventor: Kirk Joseph Witecha, Delray Beach, FL (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/550,210

(22) Filed: Oct. 17, 2006

(51) Int. Cl. H04L 9/00

(52) U.S. Cl. 705/53

(57) ABSTRACT

A telephone communication system for automatically linking a caller such as potential customer of goods or services to a supplier includes a computer having data storage such as a lookup table for storing a number of vanity identifiers and/or key words. The system also includes an automatic telephone answering device and voice recognition system for matching an individual's request with a vanity identifier. The system then automatically forwards the call to the leasee or licensee of the identified matching vanity identifier who pays for the call. A method for expanding a series of toll free numbers is also disclosed.

### FIELD OF THE INVENTION

This invention relates to telephone communication systems and methods and more particularly to automated telephone communication systems and methods for advertising goods and services, providing directory assistance and to a method for doing business.

### BACKGROUND FOR THE INVENTION

The use of toll free dialing i.e. 1-800 and 1-888 numbers are encouraged by many businesses. For example many retail establishments advertise their 1-800 numbers, frequently referred to as a vanity number, such as 1-800 FLOWERS, 1-800 LAWYERS etc. to generate large volumes of business on a national or regional scale. The problem is that there are a limited number of vanity identifiers available and once a term such as FLOWERS is taken, a competitor must find another term for their business.

The use of abbreviated dialing systems is also well known. For example, a U.S. Pat. No. 5,758,286 of Leppanen discloses a method for accomplishing a mobile telecommunication connection using abbreviated dialing. As disclosed therein, a method for placing a call from a first mobile station to a second mobile station uses predetermined abbreviated dialing. A first Subscriber dials a short number at the first mobile station which is received by a mobile telephone exchange. The short number is compared to a group of short numbers each having an associated public telephone number corresponding to a unique second mobile station. If a match is found, the associated public telephone number is dialed and a communication path is established between a first and the second mobile station. A billing record of this communication path is recorded at the mobile telephone exchange. Further, the communication between the first and second mobile stations may be marked as a transferred call to prevent further call transfers.

Telephone communication methods for facilitating business and/or on-line shopping are also known. For example, a U.S. patent of Dennert, U.S. Pat. No. 6,269,155 discloses a process for making connections and accounting for connections in telecommunication systems. A customer friendly method for call establishment and for accounting of calls in a telecommunication network is disclosed, wherein specified destination call numbers are stored in a database situated in a service node of a communication network and the database can be accessed by a subscriber by dialing a service identification number.

Further approaches for facilitating on-line shopping are also known. For example, a U.S. Patent Application Publication of Shafron et al., No. US2006/0122904 ('904) discloses a method of modifying an internet browser interface to provide shopping assistant functionality facilitating on-line shopping at a supported merchant internet site. A wallet created in accordance with the “904 application comprises a database having various user data stored therein under certain predetermined field names. A supported merchant data file identifies a plurality of supported merchants and enables the modified browser interface to determine when a shopper has navigated to a supported merchant website. For each supported merchant, a rules and mapping file is created that may be used in connection with the wallet to map user-provided information in the wallet to corresponding fields in the merchant's check-out webpage. When a user navigates to a supported merchant website and desires to purchase merchandise and/or services from that merchant, the wallet automatically fills out the merchant's check-out webpage, thereby simplifying on-line shopping and particularly, the check-out process.

A still further approach to Ecommerce methods and systems is disclosed is another U.S. Patent Application Publication No. US2006/0085276 of Hoech et al. The Hoech et al. publication discloses a method of conducting business and transactions on a network system. The method includes receiving buyer registration information from a perspective buyer, including information describing a purchasing interest. Seller information is also received which includes information describing an offer being offered by a seller. At least some of the buyer information describing the purchasing interest and at least some of the seller information describing the offer being offered are selectively matched. In response to a match and executable message is transmitted to the perspective buyer with the description of the offer allowing the prospective buyer to accept or decline the offer.

Notwithstanding the above, it is presently believed that there is a large potential market for the systems and methods in accordance with the present invention. There should be a demand because such systems should significantly increase a seller's business and have particular appeal to purchasers who are uneasy about making purchases over the internet. Further, such systems unlike internet systems are buyer-centric and provide a person-to-person interface between a potential buyer and a seller, allow a potential buyer to discuss their needs and concerns with a real person and facilitate closing a sale by a salesman. A further advantage of the present invention is that the components and/or subsystems are of conventional design.

A further advantage of the present invention resides in an ability to greatly expand the availability and use of 1 800-numbers or other series of toll free numbers. For example, the FCC issued the 1-800 series of phone numbers in 1965 and the supply ran out 30 years later. The next introduced the 888 series that ran out two years later. After that they introduced the 866 series that was fully subscribed in 6 months.

There are additional problems associated with the 888, 877 and 866 toll free numbers. The problem is that after 30 plus years of associating toll free numbers with the 1-800, many individuals dialed 1-800 when they should be dialing 1-888, 1-877 or 1-866. The present invention allows individuals to dial 1-800 followed by seven digits plus speaking a key word.

### BRIEF SUMMARY OF THE INVENTION

In essence the present invention contemplates a telephone communication system for automatically linking a caller such as a potential customer for goods and/or services an entity such as a seller of related goods and/or services. The system incorporates a computer with data storage means for storing a large number of vanity identifiers, also referred to as key words, each of which are assigned to a selected subscriber that is a seller of pre-selected goods and/or services. As used herein vanity identifiers do not always refer to a series of numbers that correspond to a descriptive word as for example 356 9377 that corresponds to “FLOWERS” OR 529 9377 that corresponds to “LAWYERS.” The use of voice recognition is a preferred embodiment of the invention which allows a provider of such services to expand the system and distinguish between multiple subscribers whose key words would convert to the same sequence of numbers on a touch tone key pad.

The system also includes a telephone answering sub-system or apparatus for automatically answering incoming calls and delivering an audio cue such as a verbal message that asks a caller to say the key word or field of interest. A first communication link for connecting an incoming call to the telephone answering apparatus is established. In addition, the system includes a voice activated voice recognition system for matching a key word expressed by a caller with a subscriber's vanity identifier that is the same or approximately the same as the key word expressed by the caller. Further, a second communication link is provided for connecting a caller to a subscriber in response to a match between an expressed key word and the subscriber's vanity identifier number.

The invention also contemplates a method of doing business which encompasses the use of a telephone communication system in accordance with a first embodiment of the invention. The method for doing business contemplates the steps of providing a communication link and a call in number such as a 1-800 FOR INFO™ (1-800-367-4636)™ that enables a caller to be connected to a subscriber, as for example, a provider of goods and or services.

The method also includes the steps of advertising the call-in number as a free service for callers to reach suppliers of goods and services by identifying their interest and to be automatically connected to a live person with knowledge of the goods and services about which the caller has an interest.

An important aspect of this embodiment of the invention resides in the steps of establishing a plurality of subscriber vanity identifiers that identify pre-selected types of goods and/or services and leasing or licensing the vanity identifiers to providers or sellers of goods and services that are associated with the vanity identifier. The methods in accordance with this embodiment of the invention also contemplates the steps of providing a telephone answering device or system for responding to incoming calls and delivering a message to a caller asking the caller to identify a key word or the like.

The invention also contemplates the steps of providing a voice activated voice recognition system and comparing a key word or field of interest expressed by a caller with a lookup table including a list of the subscribers vanity identifiers. When a match is found the caller and the subscriber are connected.

### DESCRIPTION OF THE DRAWINGS

FIG. 1 is a schematic diagram illustrating the operation of a system in accordance with a first embodiment of the invention; and

FIG. 2 illustrates the steps in a method in accordance with a second embodiment of the invention.

### DESCRIPTION OF THE PREFERRED EMBODIMENTS OF THE INVENTION

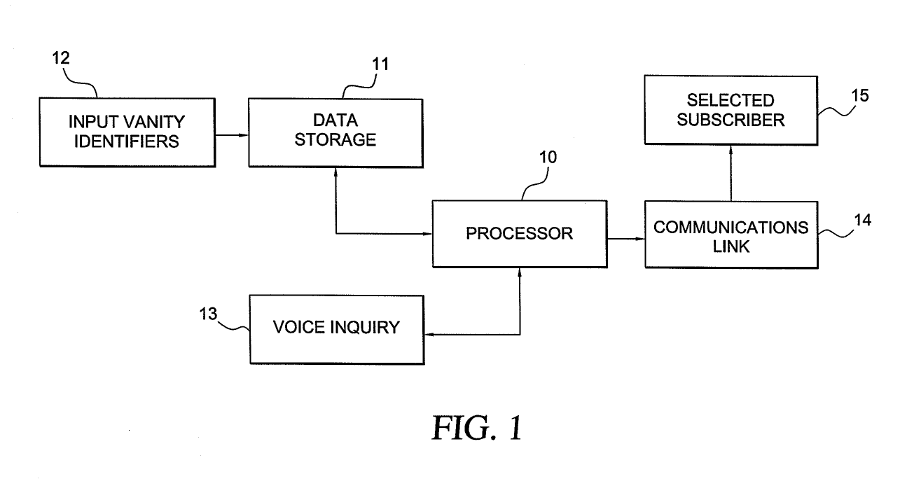

As illustrated in FIG. 1, a system in accordance with the present invention includes a computer or processor 10 for carrying out the various data processing requirements of the device and also includes a voice input unit 12 and data storage means 11. The voice input unit 12 is used to enter a plurality of subscriber vanity identifiers such as “FLOWERS,” “LAWYERS,” etc. A first communication link 13 is used for a potential customer to telephone a supplier of goods and services that will meet their needs.

For example, an individual dials the number 1-800 FOR INFO (1-800-367-4636)™ and the telephone call is automatically answered with instructions to state the goods or services which are of interest to the caller. A processor 10 compares the input voice inquiry from the communication link 13 with the stored vanity identifiers in the data storage means 11 to determine which of the voice identifiers match the input voice signal. The address corresponding to one of the telephone numbers associated with the matched voice inquiry are retrieved from the data storage means 11 such as a look-up table (not shown) and the telephone number is provided to the second communication link 14. The call is then forwarded to a selected recipient 15. In this way a potential customer is directly connected to a person or a supplier of goods and services. The supplier may also for example provide a voice menu to refine the distribution of calls to a specific department or the like before the caller is connected to a person.

When a user wishes to access the network, he or she inputs a voice signal via an input unit or voice inquiry unit 13 which is fed to the processor 10. The processor 10 compares the input voice signal with the subscriber vanity identifier stored in the data storage means 11 to determine which of the referenced voice signals match a vanity identifier. An address component associated with the matched voice signals is retrieved from the data storage means 11. The location address components are then provided by the processor 10 to the second communication link 14.

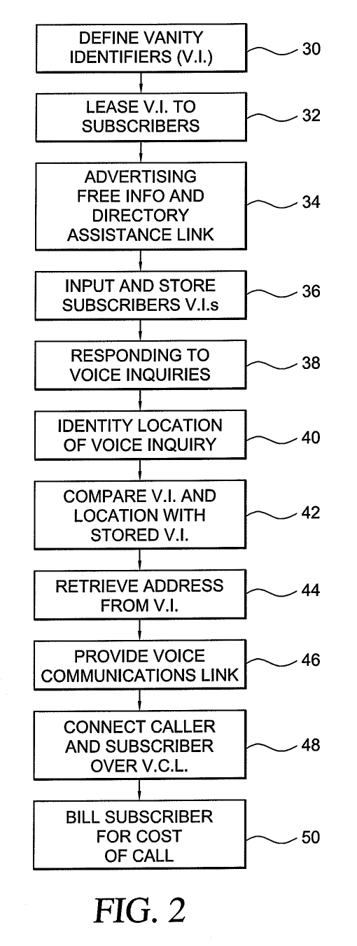

FIG. 2 is a flow diagram illustrating the steps taking in a method in accordance with a preferred embodiment of the invention. As shown, the method includes the step 30 of defining a plurality of vanity identifiers i.e. words that can be used to distinguish one product or service from another. As for example “FLOWERS,” “LAWYERS,” etc. may be used. Selected vanity identifiers are leased to suppliers of goods and services in step 32 and in step 34 the subscriber places advertisements for the 1-800 FOR INFO™ and their key word for assistance and/or free information on goods and services.

The next step 36 in the method comprises providing a computer with data storage and inputting the subscriber vanity identifiers into memory as for example in a lookup table. When a telephone inquiry is received, the method includes the step 38 of automatically responding to the inquiry with a message asking the caller say the key word. The caller may also be asked to repeat the key word and/or spell it. Upon receiving the call, the identity and location of the caller is identified in step 40 as for example with a caller ID. In one embodiment of the invention, the key information may include the location of the caller. The location is important when it is desired to license a vanity identifier for different region that may be leased for different entities i.e. companies, individuals or organizations.

A processor or computer is provided and used to compare the express field of interest with the stored vanity identifiers in step 42 and the address and phone number of the subscriber who leases a matching vanity identifier is stored in step 44. For example, the processor may be used to search a lookup table. The method further includes the step 46 of providing a second communication link and the step 48 of connecting the caller and the subscriber by means of the second communication link. Finally, the method in accordance with the present invention also includes the step 50 of billing the subscriber for the telephone call based on the time spent on the call or on a per call basis. Conventional billing techniques are used to complete the latter step.

The components and/or subsystems as used in the present invention are of conventional design. For example, an automatic answering system, voice recognition systems, call forwarding systems and caller identification systems are each highly developed, of high quality and readily available from established manufactures. For example, a method for providing an automatic directory lookup service prompts a user to enter a query as disclosed in a U.S. Patent Application Publication No. 2005/0197107 of Hasen et al. A method for call establishment and for accounting for calls in telecommunications networks whereas specified destination call numbers are stored in a data base is shown in a U.S. Pat. No. 6,269,155 of Dennert while a method and system for accessing a network using voice recognition is shown in a U.S. Pat. No. 7,062,297 of Minor et al. Each of the aforementioned patents and Patent Application Publication are incorporated herein in their entireties by reference.

It is also contemplated that at times, or at sometime in the future, a caller may be asked to key in a key word. For example, if the voice recognition system is unable to recognize a spoken key word or of the spoken key word approximates two or more registered key words, the use of a telephone keypad may be used for clarification. As presently contemplated, the use of the telephone keypad would only be used for clarification. If used broadly, it would have the same limitation of each of the three digit toll free numbers i.e. 888, 877 and 866.

While the invention has not been described in connection with its preferred embodiments, it should be recognized that changes and modifications may be made therein without departing from the scope of the claims.

What is claimed is:

1. A telephone communication system for automatically linking a caller and a subscriber, said system comprising:
a computer having data storage means for storing a plurality of subscriber vanity identifiers each of which is assigned to a selected subscriber;
a telephone answering system for responding to an incoming call and delivering a message for a caller to identify a key word and a first communication link for communicating an incoming call to said telephone answering system;
a voice activated voice recognition system for matching a key word expressed by a caller with a subscriber's vanity identifier; and
a second communication link for connecting a caller to a subscriber in response to a match between the expressed key word and the subscriber's vanity identifier number.

2. A telephone communication system for automatically linking a caller and a subscriber according to claim 1 which includes means for activating a subscriber's vanity identifier upon payment of a license fee.

3. A telephone communication system for automatically linking a caller and a subscriber according to claim 2 which includes means for charging a subscriber for a per call/time charge.

4. A method for establishing a communication link between a potential customer and a provider of pre-selected goods and/or services comprising the steps of:
establishing a plurality of subscriber identifiers;
leasing the use of said subscriber identifiers to providers of goods and/or services associated with said subscriber vanity identifiers;
providing incoming telephone links for information services and a telephone answering device for responding to incoming calls;
delivering a message to a caller to identify a key word;
providing a voice activated voice recognition system;
comparing a key word expressed by a caller with the plurality of subscriber vanity identifier;
connecting the caller and a subscriber with the vanity identifier that matches the key word expressed by the caller; and
charging the subscriber receiving the call for the costs associated with the call.

5. A method for doing business comprising the steps of:
providing a communication link and a call in number for directory assistance without charge to the caller;
establishing a plurality of subscriber identifiers that identify pre-selected organizations or individuals;
leasing the use of said subscriber identifiers to organizations and/or individuals;
promoting a service for contacting subscribers;
providing a telephone answering device for responding to incoming calls;
delivering a message to a caller to identify a key word;
providing a voice activated voice recognition system;
comparing a key word expressed by a caller with the plurality of subscriber identifiers; and
connecting the caller to the subscriber with the subscriber identifier associated with the key word expressed by the caller.

6. A method for doing business according to claim 5 which includes the step of billing the subscriber for the cost of each telephone call forwarded to the subscriber.

7. A method of doing business according to claim 6 in which incoming calls are segregated by location and forwarded to subscribers within a designated area.

8. A method for doing business according to claim 5 in which caller identifier are leased for specific areas.

9. A method of doing business according to claim 5 which includes the steps of seeking clarification of the key word by asking the caller to vocally spell the key word and comparing the spelled word with the plurality of spellings for subscriber identifier.

10. A method of doing business according to claim 5 which includes the step of training the voice activated voice recognition system by repeating key words multiple times with different pronunciations.

11. A method for expanding a series of toll free telephone numbers for communicating with an individual or organization, said method comprising the steps of:
providing a first communication link accessible to a caller by a toll free number and a second communication link for connecting a caller to an individual or organization for communications therewith;
leasing a plurality of key-word accessible identifiers to individuals or organizations;
providing a computer having a processor and data storage for storing a plurality of key words and telephone numbers associated with the key words;
providing a voice activated voice recognition system for answering a telephone call and responding to a spoken key word;
comparing a key word spoken by a caller and the key words in the data storage;
connecting a caller over the second communication link with the leasee of the key word; and
billing the leasee for the cost of the telephone call.

12. A method for expanding a series of toll free telephone numbers for communicating with an individual or organization according to claim 11 where the series of toll free telephone numbers are the 1-800 series.

13. A method for expanding the series of toll free telephone numbers for communication with individuals or organizations according to claim 11 which includes the step of dialing 1-800 and a series of seven digits to obtain access to a leasee.

14. A method for expanding a series of toll free telephone numbers for communicating with an individual or organization according to claim 13 in which the series of seven digits are 367 4636 which corresponds to FOR INFO on a telephone keypad.
